(19) United States
(12) Patent Application Publication
(10) Pub. No.: US 2011/0291960 A1
(43) Pub. Date: Dec. 1, 2011

(54) TOUCH-TYPE TRANSPARENT KEYBOARD

(75) Inventors: KUN-TSAN WU, Shindian (TW); LI-WEN TIEN, Shindian (TW)

(73) Assignee: FIH (HONG KONG) LIMITED, Kowloon (HK)

(21) Appl. No.: 12/889,595

(22) Filed: Sep. 24, 2010

(30) Foreign Application Priority Data
May 28, 2010 (CN) 201020206005.7

(51) Int. Cl. G06F 3/041

(52) U.S. Cl. 345/173

(57) ABSTRACT

A touch-type transparent keyboard is for use with an electronic device. The touch-type transparent keyboard includes a touch screen and a transparent plate. The transparent plate is attached under the touch screen. The transparent plate includes a plurality of key icons made of luminous material. The key icons can absorb energy of light it is exposed to from a display of the electronic device, ambient artificial light, and sunlight. Then the key icons will glow in the dark.

### CROSS-REFERENCE TO RELATED APPLICATIONS

This application is one of the six related co-pending U.S. patent applications listed below. All listed applications have the same assignee and were concurrently filed herewith. The disclosure of each of the listed applications is incorporated by reference into all the other listed applications.

| Attorney Docket No. | Title | Inventors |
|---|---|---|
| US33515 | TOUCH-TYPE TRANSPARENT | Wu et al. |
| | KEYBOARD | |
| US33516 | TOUCH-TYPE TRANSPARENT | Wu et al. |
| | KEYBOARD | |
| US33517 | TOUCH-TYPE TRANSPARENT | Wu et al. |
| | KEYBOARD | |
| US33518 | TOUCH-TYPE TRANSPARENT | Wu et al. |
| | KEYBOARD | |
| US33519 | TOUCH-TYPE TRANSPARENT | Wu et al. |
| | KEYBOARD | |
| US33520 | TOUCH-TYPE TRANSPARENT | Wu et al. |
| | KEYBOARD | |

### BACKGROUND

1. Technical Field

The present disclosure generally relates to touch-type transparent keyboards, and particularly, to a touch-type transparent keyboard for use with an electronic device.

2. Description of Related Art

For operating electronic devices, keyboards, mice, trackballs and remote controls are important user interfaces for controlling cursors or inputting instructions. Currently, standard mechanical keyboards are widely for use with industrial or residential fields for inputting information to computers. Mechanical keyboards may make noise while being used for typing. In addition, in order to identify key icons of the keyboards in a dark environment, a cap of each key is made of transparent material, and a light emitting element is set below each cap. However, these kinds of keyboards waste energy, and do not meet energy conservation requirements.

Therefore, there is a room for improvement within the art.

### BRIEF DESCRIPTION OF THE DRAWINGS

Many aspects of the touch-type transparent keyboard can be better understood with reference to the following drawings. The components in the drawings are not necessarily to scale, the emphasis instead being placed upon clearly illustrating the touch-type transparent keyboard. Moreover, in the drawings, like reference numerals designate corresponding parts throughout the several views.

FIG. 1 is a partially exploded and isometric view of a touch-type transparent keyboard, according to an exemplary embodiment.

FIG. 2 is a cross-sectional view of a touch screen of the touch-type transparent keyboard shown in FIG. 1.

FIG. 3 is an assembled view of the touch-type transparent keyboard shown in FIG. 1.

FIG. 4 is an assembled view of the touch-type transparent keyboard shown in FIG. 3, but shown from another aspect.

### DETAILED DESCRIPTION

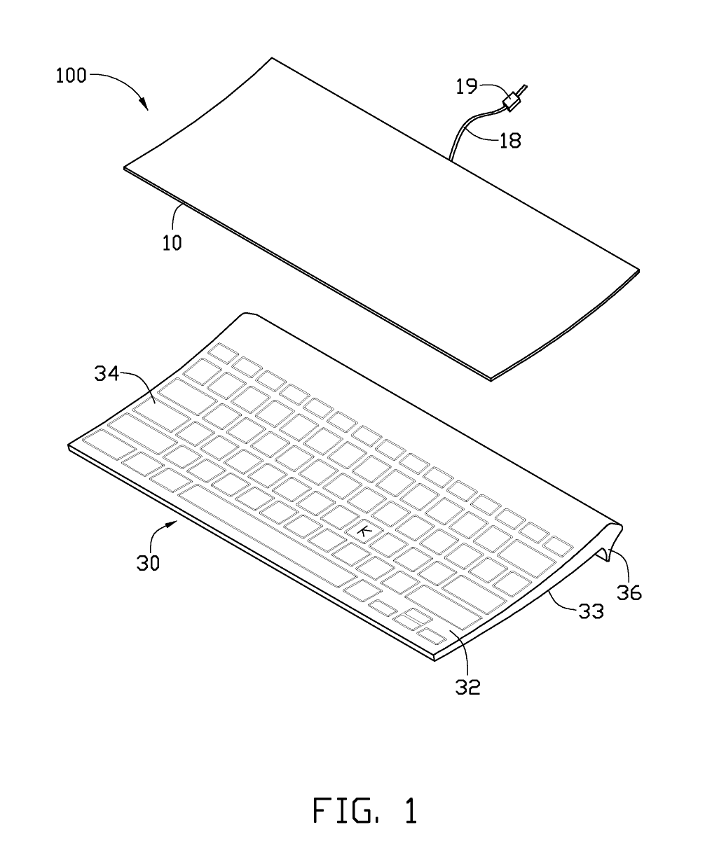

Referring to FIG. 1, the present disclosure provides a touch-type transparent keyboard 100 for use with an electronic device. The electronic device can be, but is not limited to, a smart phone, a mobile phone, a personal digital assistant (PDA), an e-book reader, or a notebook computer. In an exemplary embodiment, the touch-type transparent keyboard 100 includes a touch screen 10 and a transparent plate 30. The touch screen 10 connected to the transparent plate 30. Using a finger or a touching tool to touch the touch screen 10, users can input instructions to control the electronic device.

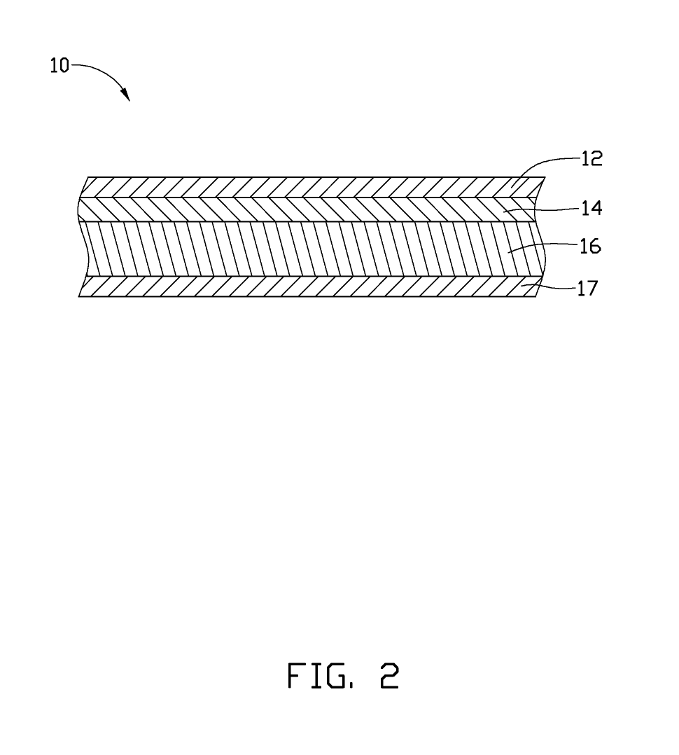

Referring to FIG. 2, the touch screen 10 may be a transparent capacitive touch screen including a transparent protective layer 12, a first conducting layer 14, a transparent main body 16, a second conducting layer 17, a connecting wire 18, and a control module 19. The transparent protective layer 12 may be made of silicon dioxide (SiO) or polyethylene terephthalate (PET). The first conducting layer 14 is attached to the transparent protective layer 12, and may be made of indium tin oxide (ITO), aluminum-doped zinc oxide, or cadmium oxide (CdO). The first conducting layer 14 is configured for detecting a touch position. The transparent main body 16 is attached to the first conducting layer 14, and may be made of transparent glass or transparent plastic. The second conducting layer 17 is coated on the transparent main body 16, and may be made of transparent conducting material and help protect the transparent main body 16. The connecting wire 18 connects the touch screen 10 to a computer. The control module 19 may be an integrated chip disposed on the connecting wire 18 and is electrically connected to the first conducting layer 14, the second conducting layer 17, and the connecting wire 18 by flexible cables. When a user touches somewhere on the transparent protective layer 12 hard, the control module 19 can determine position coordinates of the touch, and generate a command signal to the electronic device associated with that touch point.

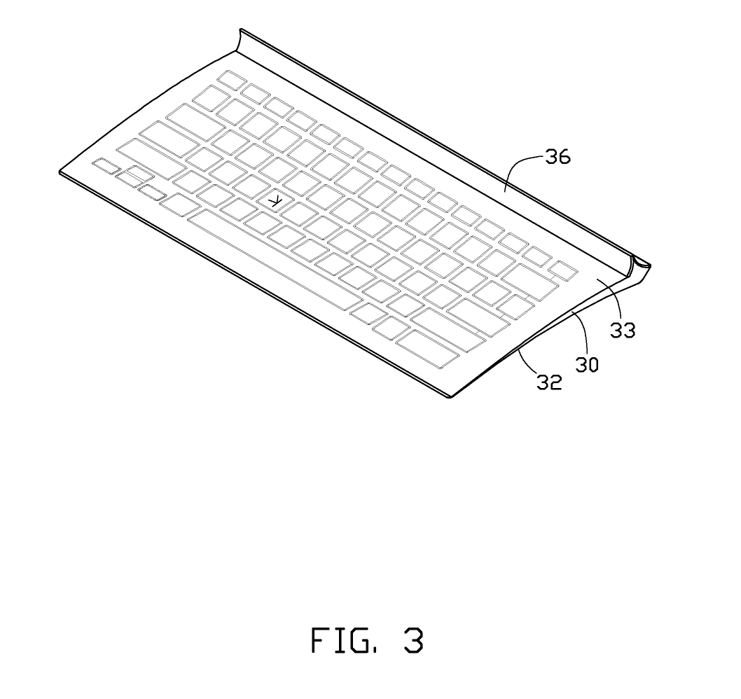

Referring to FIG. 3, the transparent plate 30 can be made of transparent glass or transparent resin, and is configured for supporting the touch screen 10. The transparent plate 30 includes a first surface 32 and an opposite second surface 33. The first surface 32 may be adhered to the second conducting layer 17.

A plurality of key icons 34 connected to the first surface 32 of the transparent plate 30. The key icons 34 are made of luminous material printed or sprayed on the first surface 32. In the exemplary embodiment, the key icons 34 are made of calcium sulfide (CaS), zinc sulphide (ZnS), or strontium sulfide (SrS). The key icons 34 can absorb energy from various kinds of light such as emitted by a display of the electronic device, artificial ambient light, and sunlight and then the key icons 34 will glow in the dark so that the key icons 34 can be readily seen by users. When the display is used, the key icons 34 will continuously absorb the light energy emitting from the display, to ensure that the key icons 34 can continuously glow in the dark. The key icons 34 are positioned at predetermined touch points on the touch screen 10 whose coordinates are stored in the control module 19 and associated with various commands. Users can be guided in accurately inputting commands to the electronic device by being able to see the key icons 34 through the transparent touch screen 10 and touching those points on the touch screen 10 aligned with the key icons 34. Naturally, the key icons 34 can be arranged and the predetermined touch points configured to input characters, numbers, and commands in the same way as with a standard keyboard but not necessarily so. A supporting portion 36 is positioned on the second surface 33 to support the touch-type transparent keyboard 100. In the exemplary embodiment, the supporting portion 36 is made of transparent material and a cross section of the supporting portion 36 may be substantially triangular.

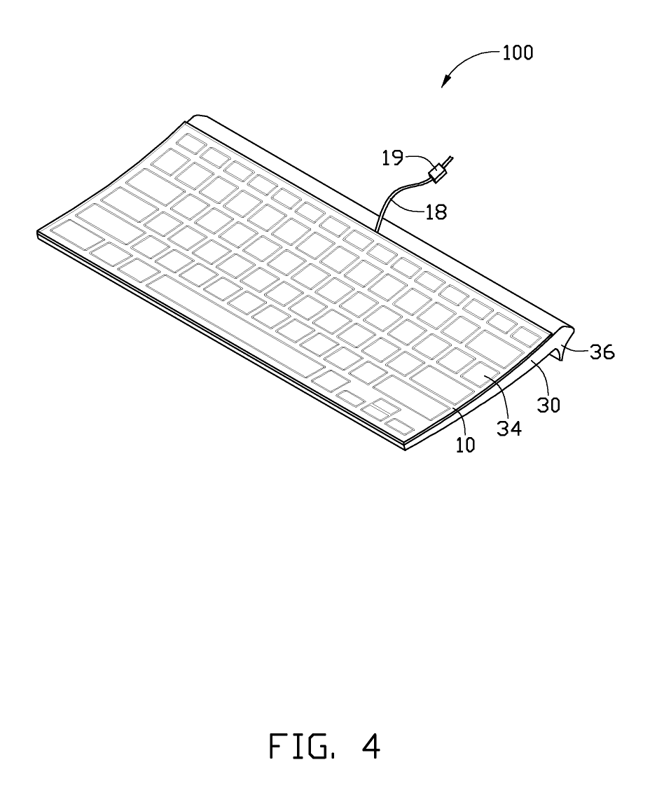

Referring to FIG. 4, when using the touch-type transparent keyboard 100 in the dark environment, the key icons 34 can absorb energy from the light of the display of the electronic device, and then glow in the dark. When users touch the touch screen 10, the control module 19 determines coordinates of the touched point and compares the coordinates with the coordinate information of predetermined touch points to output the command signal corresponding to the touch point.

In another exemplary embodiment, the key icons 34 are disposed on the second surface 33 of the transparent plate 30.

In another exemplary embodiment, the key icons 34 are disposed on the touch screen 10. To prevent the key icons 34 from being scraped, a transparent protective layer can be attached to the touch screen 10, and the key icons 34 are sandwiched between the touch screen 10 and the transparent protective layer.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A touch-type transparent keyboard, comprising:
a touch screen; and
a transparent plate positioned under the touch screen, the transparent plate comprising a plurality of key icons made of luminous material, the key icons absorbing light energy to illuminate.

2. The touch-type transparent keyboard as claimed in claim 1, wherein the key icons are disposed on the transparent plate adjacent to the touch screen.

3. The touch-type transparent keyboard as claimed in claim 1, wherein the key icons are disposed on the transparent plate away from the touch screen.

4. The touch-type transparent keyboard as claimed in claim 1, wherein the key icons are made of calcium sulfide, zinc sulphide, or strontium sulfide.

5. The touch-type transparent keyboard as claimed in claim 1, wherein the transparent plate comprises a transparent supporting portion positioned on the transparent plate, a cross section of the supporting portion is triangular.

6. The touch-type transparent keyboard as claimed in claim 1, wherein the touch screen comprises a transparent protective layer, a first conducting layer, a transparent main body, and a second conducting layer stacked in turn.

7. A touch-type transparent keyboard, comprising:
a touch screen comprising a plurality of key icons made of luminous material, the key icons absorbing light energy to illuminate; and
a transparent plate positioned under the touch screen.

8. The touch-type transparent keyboard as claimed in claim 7, wherein the touch screen comprises a transparent protective layer, a first conducting layer, a transparent main body, and a second conducting layer stacked in turn; the key icons are disposed on the transparent protective layer.

9. The touch-type transparent keyboard as claimed in claim 8, wherein the touch screen further comprises a transparent protective layer coating on the transparent protective layer.

10. The touch-type transparent keyboard as claimed in claim 7, wherein key icons are made of calcium sulfide, zinc sulphide, or strontium sulfide.

11. The touch-type transparent keyboard as claimed in claim 7, wherein the transparent plate comprises a transparent supporting portion positioned on the transparent plate, a cross section of the supporting portion is triangular.

12. A touch-type transparent keyboard for use with an electronic device, the touch-type transparent keyboard comprising:
a touch screen;
a control module electrically connected to the touch screen; and
a transparent plate comprising a plurality of key icons made of luminous material, the transparent plate attached to the touch screen; the key icons absorbing light energy to illuminate;
wherein when a touching position corresponding to the key icons of the touch screen are touched, the control module detects a touch position coordinate and produces a corresponding command signal to the electronic device, and an image is shown on the electronic device.

13. The touch-type transparent keyboard as claimed in claim 12, wherein the key icons are disposed on the transparent plate adjacent to the touch screen.

14. The touch-type transparent keyboard as claimed in claim 12, wherein the key icons are disposed on the transparent plate away from the touch screen.

15. The touch-type transparent keyboard as claimed in claim 12, wherein the key icons are made of calcium sulfide, zinc sulphide, or strontium sulfide.

16. The touch-type transparent keyboard as claimed in claim 12, wherein the transparent plate comprises a transparent supporting portion positioned on the transparent plate, a cross section of the supporting portion is triangular.
